(19) United States
(12) Patent Application Publication
(10) Pub. No.: US 2025/0271823 A1
(43) Pub. Date: Aug. 28, 2025

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Gen LI, Kawasaki Kanagawa (JP); Masaaki TAKADA, Kashiwa Chiba (JP)

(73) Assignee: KABUSHIKI KAISHA TOSHIBA, Tokyo (JP)

(21) Appl. No.: 19/043,620

(22) Filed: Feb. 3, 2025

(30) Foreign Application Priority Data
Feb. 27, 2024 (JP) 2024-027486

(51) Int. Cl. G05B 13/04

(52) U.S. Cl. CPC G05B 13/042; G05B 13/041

(57) ABSTRACT

According to an embodiment, an information processing device includes one or more processors. The one or more processors are configured to: set, for each of a plurality of parameters corresponding to a plurality of explanatory variables included in a first model that inputs the plurality of explanatory variables and performs estimation, a constraint condition including a first range of a value of the corresponding parameter; and construct the first model by obtaining the plurality of parameters that satisfy the constraint condition.

### CROSS-REFERENCE TO RELATED APPLICATIONS

This application is based upon and claims the benefit of priority from Japanese Patent Application No. 2024-027486, filed on Feb. 27, 2024; the entire contents of which are incorporated herein by reference.

### FIELD

Embodiments described herein relate generally to an information processing device, an information processing method, and a computer program product.

### BACKGROUND

In production systems such as a factory (semiconductor factory etc.) and a plant (chemical plant etc.), various kinds of products are mass-produced. In recent years, a large amount of process data can be acquired from sensors disposed for respective manufacturing processes in short cycles (for example, every day). By analyzing accumulated data, measures for suppressing variation in quality can be devised. Such measures improve productivity and yield.

One of such measures employs regression analysis using a model (regression model) constructed by machine learning etc. The regression model is, for example, a model using process data such as a sensor value, a set value, and a control value as explanatory variables, and using quality characteristics as objective variables. With the regression model, a primary factor (cause) of variation in quality characteristics can be analyzed.

### BRIEF DESCRIPTION OF THE DRAWINGS

FIG. 1 is a block diagram of an information processing system according to a first embodiment;

FIG. 2 is a flowchart of information processing in the first embodiment;

FIG. 3 is a block diagram of an information processing system according to a second embodiment;

FIG. 4 is a flowchart of information processing in the second embodiment;

FIG. 5 is a diagram for explaining a setting method for a range of coefficients;

FIG. 6 is a diagram illustrating an example of a display screen to be output;

FIG. 7 is a diagram illustrating an example of a display screen to be output;

FIG. 8 is a diagram illustrating an example of a display screen to be output;

FIG. 9 is a diagram illustrating an example of a display screen to be output;

FIG. 10 is a diagram illustrating an example of a display screen to be output;

FIG. 11 is a block diagram of an information processing system according to a third embodiment;

FIG. 12 is a flowchart of information processing in the third embodiment;

FIG. 13 is a block diagram of an information processing system according to a fourth embodiment;

FIG. 14 is a flowchart of information processing in the fourth embodiment; and

FIG. 15 is a hardware configuration diagram of an information processing device according to the embodiments.

### DETAILED DESCRIPTION

In general, according to one embodiment, an information processing device includes one or more processors. The one or more processors are configured to: set, for each of a plurality of parameters corresponding to a plurality of explanatory variables included in a first model that inputs the plurality of explanatory variables and performs estimation, a constraint condition including a first range of a value of the corresponding parameter; and construct the first model by obtaining the plurality of parameters that satisfy the constraint condition.

Exemplary embodiments of an information processing device will be explained below in detail with reference to the accompanying drawings. The present invention is not limited to the following embodiments.

In factor analysis using a regression model, a model having high interpretability such as a linear model, a decision tree, and an additive model is often used. For each explanatory variable, an amount representing influence of a parameter of the model on output of the model is calculated, and a factor for explaining variation in quality characteristics can be specified by using the calculated amount.

The parameter of the model is, for example, a regression coefficient of a regression model, importance, and the like. The following mainly describes an example of using a regression model as the model, and using a coefficient (regression coefficient) as the parameter of the model. An applicable model and parameters of the model are not limited thereto.

Trends of data in production systems and the like may vary moment by moment. To always grasp the latest trends, the model is required to be regularly updated using the latest data. On the other hand, the number of pieces of data is reduced when only the latest data is used, so that influence of noise is strengthened, and an estimated coefficient may greatly differ from the perception of an expert. At a manufacturing site, when even a few coefficients differing from perception is included, reliability of the model itself is lost, and the model may be determined to be inappropriate to be used.

To avoid such a problem, developed is a technique of reconstructing the model after performing processing such as changing a size of data (sample size) used for estimating a coefficient, or changing a seed of a random number. A technique has been developed of constructing, in a case in which an ideal model is obtained such that all coefficients fall within an expected range, a model with a constraint to reduce a difference from the coefficient of the ideal model.

Experts on production systems have rich domain knowledge about a relation between quality characteristics, and a device and a sensor. Thus, the constructed model rarely completely matches the domain knowledge.

Even when the technique of reconstructing the model is applied while changing a condition, all of the coefficients do not necessarily fall within the expected range that is determined based on the domain knowledge of experts. Reconstruction may be repeatedly performed until an expected result is obtained, but a processing load may be increased.

Even if the technique of constructing a model with a constraint to reduce a difference from the coefficient of the ideal model is applied, a coefficient within the expected range is not necessarily obtained. In this technique, the range of the coefficient is not designated but an ideal value is set, so that a bias is increased if the coefficient is slightly shifted from the ideal value, and accuracy of the model is lowered.

Thus, for example, the information processing device according to the following embodiments gives, as a constraint, a range of coefficients that the experts on production systems and the like consider to be appropriate at the time of constructing the model. Due to this, a model including coefficients within the expected range can be constructed. For example, the information processing device according to the embodiments sets the range of the coefficient for each explanatory variable, and constructs the model with the range of the coefficient as a constraint. Due to this, the model including the coefficients within the set range can be obtained.

### First Embodiment

The following describes an embodiment of constructing a model that can be used for quality management in a production system. As described above, the production system takes a measure of improving a yield by suppressing unevenness and variation in quality characteristics and reducing faults. To clarify a factor of unevenness and variation in quality characteristics, for example, a regression model is used.

A product becomes a finished product via a large number of manufacturing steps. In a case of a use for analyzing a factor of variation in quality characteristics of the finished product, the model is constructed by using, as explanatory variables of the model, information such as a type of a manufacturing device at each manufacturing step and a sensor value detected by a sensor disposed on the manufacturing device and the like. The information such as the type of the manufacturing device and the sensor value can be interpreted as a characteristic amount representing a characteristic of an object to be analyzed such as a production system.

The manufacturing device deteriorates over time, so that trends of process data to be acquired are also changed. Furthermore, work that influences trends of the process data such as regular maintenance and part replacement may be performed. Thus, for example, the model is updated in accordance with a change of trends of the process data.

In the model of the present embodiment, for example, an objective variable is a variable indicating a quality characteristic, a fraction defective, or indicating whether the product is a good product or a defective product. The objective variable may be a sensor value detected by the sensor. The explanatory variable is another sensor value, a set value, a control value, or the like. The explanatory variable may be subjected to preprocessing in advance. The preprocessing is, for example, standardization, normalization, conversion with a specific function, addition of an interaction term, a time lag, a time lead, making a dummy variable, encoding, outlier processing, and missing value processing.

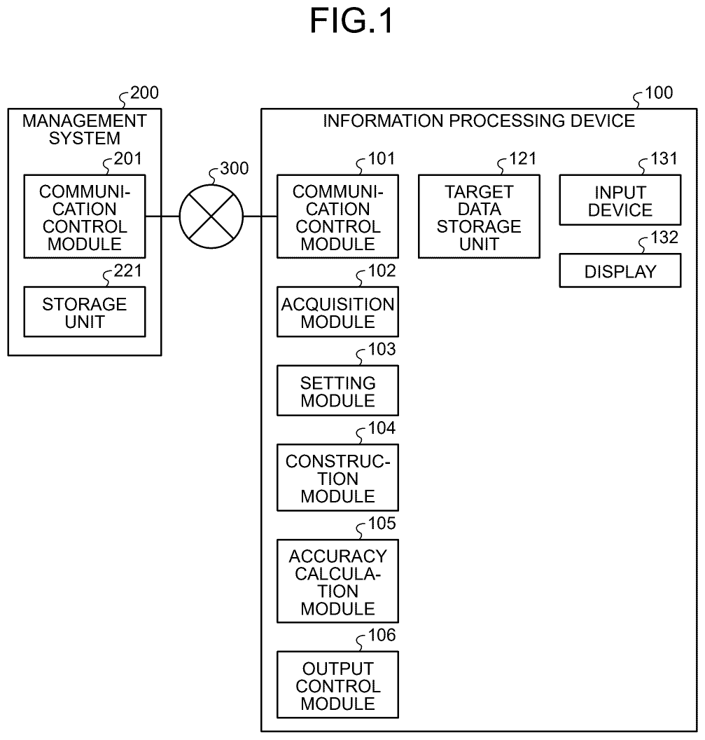

FIG. 1 is a block diagram illustrating an example of a configuration of an information processing system including an information processing device according to the present embodiment. As illustrated in FIG. 1, the information processing system has a configuration in which an information processing device 100 and a management system 200 are connected via a network 300.

Each of the information processing device 100 and the management system 200 can be configured as a server device, for example. The information processing device 100 and the management system 200 may be implemented as a plurality of devices (systems) that are physically independent, or respective functions thereof may be configured in a physically single device. In the latter case, the network 300 is not necessarily provided. At least one of the information processing device 100 and the management system 200 may be constructed in a cloud environment.

The network 300 is a network such as a local area network (LAN) and the Internet, for example. The network 300 may be any of a wired network and a wireless network. The information processing device 100 and the management system 200 may transmit/receive data using direct wired connection or wireless connection between components without the network 300.

The management system 200 is a system that manages data used for analysis and learning (construction, update) of a model. The management system 200 includes a storage unit 221 and a communication control module 201.

The storage unit 221 stores various kinds of information used for various kinds of processing performed by the management system 200. For example, the storage unit 221 stores data (process data and the like) including the objective variable and the explanatory variable. The storage unit 221 can be configured by any storage medium that is generally used such as a flash memory, a memory card, a random access memory (RAM), a hard disk drive (HDD), and an optical disc.

The communication control module 201 controls communication with an external device such as the information processing device 100. For example, the communication control module 201 transmits process data to the information processing device 100.

Each of the components described above (communication control module 201) is, for example, implemented by one or a plurality of processors. For example, each of the components described above may be implemented by causing a processor such as a central processing unit (CPU) and a graphics processing unit (GPU) to execute a computer program, that is, by software. Each of the components described above may be implemented by a processor such as a dedicated integrated circuit (IC), that is, by hardware. Each of the components described above may be implemented by using both software and hardware.

The information processing device 100 includes a target data storage unit 121, an input device 131, a display 132, a communication control module 101, an acquisition module 102, a setting module 103, a construction module 104, an accuracy calculation module 105, and an output control module 106.

The target data storage unit 121 stores various kinds of information used for various kinds of processing performed by the information processing device 100. For example, the target data storage unit 121 stores information (process data and the like) acquired from the management system 200 via the communication control module 101 and the acquisition module 102, parameters (coefficients) of a model constructed by the construction module 104, and the like. The target data storage unit 121 can be configured by any storage medium that is generally used such as a flash memory, a memory card, a RAM, an HDD, and an optical disc.

The input device 131 is a device for inputting information by a user and the like. The input device 131 is, for example, a keyboard and a mouse. The display 132 is an example of an output device that outputs information and is, for example, a liquid crystal display. The input device 131 and the display 132 may be integrated with each other like a touch panel, for example.

The communication control module 101 controls communication with an external device such as the management system 200. For example, the communication control module 101 receives process data and the like from the management system 200. The communication control module 101 also transmits a transmission request and the like for process data in a designated period to the management system 200.

The acquisition module 102 acquires various kinds of information. For example, the acquisition module 102 acquires process data received from the management system 200 via the communication control module 201 and the communication control module 101.

For example, the acquisition module 102 acquires, as data to be analyzed (target data), process data of a designated period or process data having a designated sample size from the management system 200 via the communication control module 101.

The setting module 103 sets a constraint condition used when the construction module 104 constructs a model MA. The model MA is a model (first model) to which a plurality of explanatory variables are input to estimate an objective variable. The constraint condition is a constraint condition for a plurality of coefficients (parameters) included in the model MA. For example, the constraint condition includes a range R1 (first range) of a value of a coefficient for each of the coefficients.

The construction module 104 constructs the model MA by obtaining a plurality of coefficients that satisfy the constraint condition set by the setting module 103.

The accuracy calculation module 105 calculates accuracy of the constructed model MA. For example, the accuracy calculation module 105 performs estimation with the model MA using, as data for verification, process data used for construction or process data different from the process data used for construction, and calculates the accuracy of the model MA based on a difference between an estimated objective variable and an objective variable included in the process data.

The output control module 106 controls output of various kinds of information used by the information processing device 100. For example, the output control module 106 causes information (accuracy, a coefficient, and the like) of the model MA constructed by the construction module 104 to be displayed on the display 132. Due to this, for example, the experts can determine whether the estimated coefficient falls within an expected range.

At least part of the components described above (the communication control module 101, the acquisition module 102, the setting module 103, the construction module 104, the accuracy calculation module 105, and the output control module 106) may be implemented by one or more processing units. Each of the components described above is implemented by one or a plurality of processors, for example. For example, each of the components described above may be implemented by causing a processor such as a CPU and a GPU to execute a computer program, that is, by software. Each of the components described above may be implemented by a processor such as a dedicated IC, that is, by hardware. Each of the components described above may be implemented by using both software and hardware. In a case of using a plurality of processors, each processor may implement one of the components, or may implement two or more of the components.

Next, the following further describes details about processing performed by the components of the information processing device 100.

In the following description, it is assumed that there are a total of n pieces of data (target data, process data) (n is an integer number equal to or larger than 2) acquired by the acquisition module 102, and each piece of the data includes numerical values representing p explanatory variables (p is an integer number equal to or larger than 1) and one objective variable. That is, the data is represented as (xᵢ, yᵢ), xᵢ∈R^{p}, yᵢ∈R, i=1, . . . , n. xᵢ is an explanatory variable of a p-dimensional column vector. yᵢ is a scalar objective variable.

For example, in a case of a linear regression model, the construction module 104 estimates a parameter of the model MA, that is, a coefficient for each explanatory variable by solving an optimization problem represented by the following expression (1) using the acquired data.

$$\hat{β} = arg {min}_{{β}_{0} , β} {\sum }_{i} {( {y}_{i} - {β}_{0} - {β}^{T} {x}_{i} )}^{2} subject to {β}_{{j}_{low}} \leq {β}_{j} \leq {β}_{{j}_{up}} , \\ j = 1 , ... , p \qquad ( 1 )$$

A vector β is a vector including, as an element, a coefficient βⱼ (j is an integer number satisfying 1≤j≤p) that is set per p elements of the explanatory variable xᵢ. β_{j_low} and β_{j_up} respectively represent a lower limit and an upper limit of a value of the coefficient βⱼ. In the expression (1), “β_{j_low}≤βⱼ≤β_{j_up}” corresponds to a constraint condition representing the range R1 of the value of the coefficient βⱼ. That is, as represented by the expression (1), for example, the setting module 103 sets the constraint condition representing the range R1 with the lower limit β_{j_low} and the upper limit β_{j_up}.

To configure the constraint condition for the coefficients per p elements of the explanatory variable xᵢ, the setting module 103 acquires information about presence/absence of a constraint from the user or the management system 200. The information about presence/absence of a constraint is information indicating whether to impose a constraint on the coefficients corresponding to the p elements of the explanatory variable xᵢ. For the coefficient without a constraint, the setting module 103 does not impose a constraint thereon, or adds β_{j_low}=−∞ and β_{j_up}=+∞ as the range R1 (constraint range) thereto. For the coefficient with a constraint, the setting module 103 sets at least one of an upper limit and a lower limit as the range R1 of the coefficient. If the upper limit is not set, +∞ may be set, and if the lower limit is not set, −∞ may be set. If the upper limit is a positive value and the lower limit is not set, the lower limit may be set to be zero. If the lower limit is a negative value and the upper limit is not set, the upper limit may be set to be zero. The setting module 103 may set both of the lower limit and the upper limit as the range R1 of the coefficient.

In the expression (1), a term of Σ corresponds to a loss function. The construction module 104 constructs the model MA by obtaining, using such a loss function, a plurality of parameters (coefficients) that minimize a loss calculated by the loss function. That is, by using the expression (1), the construction module 104 can estimate β\hat{ } under the constraint condition representing the range R1 of the value of the coefficient βⱼ.

In the expression (1), the loss function using a square error is used, but the loss function is not limited thereto. For example, as the loss function, absolute value loss, quantile loss, Huber loss, cross entropy loss, epsilon sensitivity loss, logistic loss, 0-1 loss, exponential loss, hinge loss, smoothed hinge loss, and the like may be used. A loss function that is weighted in accordance with date and time, and reliability of each piece of data may be used.

The loss function may include a penalty (regularization term) such as Ridge, Least absolute shrinkage and selection operator (Lasso), Smoothly Clipped Absolute Derivation (SCAD), Minimax Concave Penalty (MCP), Lq norm (0≤q<1), and Elastic Net in addition to penalties related to the constraint for the range of the coefficient.

The model to which the present embodiment can be applied is not limited to the linear regression model, but may be any model represented by using parameters. For example, a logistic regression model, a Poisson regression model, a generalized linear model, a generalized additive model, a decision tree, a neural network, and the like may be used.

The loss function including the constraint condition for the range of the coefficient is not limited to the expression (1), but may be any other function. For example, as represented by the following expression (2), the range of the coefficient may be constrained by using a link function.

$$\hat{β} = arg {min}_{{β}_{0} , β} {\sum }_{i} {( {y}_{i} - {β}_{0} - {η ( α )}^{T} {x}_{i} )}^{2} \qquad ( 2 )$$

In expression (2), α and xᵢ are vectors in which αⱼ and xᵢⱼ are respectively arranged in a column. In a case of using a logistics function as η(⋅) representing a link function, the coefficient β can be represented as in the following expression (3).

$${β}_{j} = η ( {α}_{j} ) = {β}_{j \_ low} + \frac{{β}_{{j}_{- up}} - {β}_{j \_ low}}{1 + {e}^{- {α}_{j}}} \qquad ( 3 )$$

The link function is not limited to the logistics function. For example, an exponential function, a logarithm function, a softmax function, and the like may be used.

An optimization method for solving an optimization problem by the construction module 104 may be any method. For example, the following methods can be applied.
(M1) Perform linear or nonlinear sequential optimization by using an optimization solver.
(M2) Use an internal point method, a trust region Reflective method, and the like as an algorithm used by the optimization solver.
(M3) Repeat the following procedures from 3-1 to 3-4 until all of the coefficients satisfy the constraint.
   3-1: Estimate a parameter without a constraint.
   3-2: From among explanatory variables (p elements of the explanatory variable xᵢ) whose coefficients are outside the range R1, select an explanatory variable xₖ whose coefficient is farthest from or closest to the upper limit or the lower limit of the range R1 (k is an integer number satisfying 1≤k≤p).
   3-3: Set a coefficient βₖ of the selected explanatory variable xₖ to the upper limit or the lower limit closer to the coefficient βₖ.
   3-4: Update the objective variable to y_{i_new}=yᵢ−xₖβₖ, and exclude the explanatory variable xₖ.
(M4) Allow the value of the coefficient to exceed the given range.

The following describes details about (M4). The loss function described above can be interpreted as an example of using a constraint (hard constraint) indicating that the coefficient necessarily falls within the given range. The loss function can be configured to use a constraint (soft constraint) to cause the value of the coefficient to fall within the range if possible while allowing it to exceed the given range. (M4) corresponds to an optimization method using such a loss function. The following expression (4) indicates an example of a loss function that can be applied to (M4). Expression (4) can be interpreted as a loss function with which a loss becomes smaller as the degree of satisfaction of the constraint condition is higher.

$$\hat{β} = arg {min}_{{β}_{0} , β} {\sum }_{i} {( {y}_{i} - {β}_{0} - {β}^{T} {x}_{i} )}^{2} + λ {\sum }_{j} L ( g ( {β}_{j} , {β}_{{j}_{- up}} , {β}_{{j}_{- low}} ) ) , \qquad ( 4 )$$

$$g ( {β}_{j} , {β}_{j \_ up} , {β}_{j \_ low} ) = \{ \begin{matrix}{β}_{j} - {β}_{j \_ up} , & if {β}_{j} > {β}_{j \_ up} \\ {β}_{j} - {β}_{j \_ low} , & if {β}_{j} < {β}_{j \_ low} \\ 0 , & else\end{matrix}$$

λ is a parameter for adjusting a balance between a sum-of-square error and a penalty term. As a function L(⋅), an Lq (0<=q) norm, an exponential function, a logarithm function, and the like can be used. A reference value β_{j_ref} may be additionally given to a function g(⋅) as a parameter, and in a case of “else”, |βⱼ−β_{j_ref}| may be returned as a result of g(⋅).

When construction of the model is completed, the coefficient for each explanatory variable can be obtained. The accuracy calculation module 105 can calculate accuracy of the constructed model. The output control module 106 may directly present the calculated accuracy of the model to the user via an output device such as the display 132. In a case in which the accuracy of the model as the reference value is obtained, the output control module 106 may output the reference value together with the calculated accuracy. The output control module 106 may output the coefficient for each explanatory variable together with at least one of the upper limit and the lower limit set for the coefficient.

Values of the lower limit and the upper limit of the range R1 set by the setting module 103 are designated by the user (expert) or the management system 200, for example. As the lower limit and the upper limit, different values may be set in accordance with two or more levels.

The following describes an example of switching the values of the lower limit and the upper limit in accordance with a plurality of levels. Considering a use for quality management in mass production of products, different management levels for the coefficients may be set for respective explanatory variables (p elements of the explanatory variable xᵢ). At the respective management levels, setting methods for the range R1 are different from each other. The following describes a method of managing the range of the coefficient of each explanatory variable at three management levels using finishing concentration of a certain material contained in a manufactured product as the objective variable.
(High level) In a case in which injection concentration of a certain material used for manufacturing the product is the explanatory variable, a relation between the explanatory variable and the objective variable can be determined based on domain knowledge, so that the upper limit and the lower limit of the coefficient are set to be a relatively narrow range based on the domain knowledge.
(Intermediate level) In a case in which a temperature of a manufacturing environment is the explanatory variable, it can be found that the explanatory variable has a positive relation with the objective variable, so that the upper limit=∞ and the lower limit=0 are set as the range of the coefficient. That is, only a sign of the coefficient is managed.
(Low level) In a case of the explanatory variable having an unclear relation with the objective variable, the upper limit=∞ and the lower limit=−∞ are set. In this case, the explanatory variable may be excluded from a management target, and configured not to be included in the constraint at the time of constructing the model.

In this way, by setting the appropriate range R1 of the coefficient for each management level of the explanatory variable and constructing the model with the set range R1 as the constraint condition, the model is securely constructed with the coefficients within the range expected by the experts at the manufacturing site. By visualizing the estimated coefficient and the range of the coefficient at the same time to be presented to the experts, reliability of the model for the experts can be improved.

Next, the following describes information

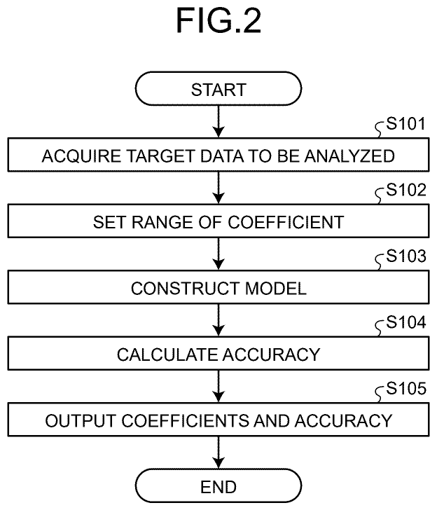

processing performed by the information processing device 100 according to the first embodiment. FIG. 2 is a flowchart illustrating an example of the information processing in the first embodiment.

The acquisition module 102 acquires target data to be analyzed (Step S101). For example, the acquisition module 102 transmits a transmission request for process data of a period or a size designated by the user and the like to the management system 200, and acquires, as target data, the process data transmitted from the management system 200 in response to the transmission request.

The setting module 103 sets the range R1 of the coefficient as the constraint condition used at the time of constructing the model MA using the acquired target data (process data) (Step S102). The construction module 104 constructs the model MA by obtaining a plurality of coefficients that satisfy the set constraint condition (Step S103).

The accuracy calculation module 105 calculates accuracy of the constructed model MA (Step S104). The output control module 106 outputs the coefficients of the constructed model MA and the calculated accuracy (Step S105), and ends the information processing.

In this way, the information processing device according to the first embodiment can construct the model including the coefficients within the expected range when the range of the coefficient designated by the experts and the like is given as the constraint at the time of constructing the model. Due to this, a more appropriate model can be constructed.

### Second Embodiment

In the first embodiment, the range R1 for each coefficient is designated by the user and the like, for example, at the time of constructing the model. In the second embodiment, a more appropriate range R1 of the coefficient is set based on at least one of the domain knowledge and the coefficients of the model constructed in the past.

For example, the production system regularly updates the model, and holds information about the model constructed in the past in many cases to analyze an abnormality factor and the like. In such a case, the transition of a coefficient of a specific explanatory variable in a past normal period may constitute grounds for determining an appropriate range of the coefficient. On the other hand, for example, a manufacturing process of a semiconductor and the like includes a large number of steps. Extensive domain knowledge about such a manufacturing process is managed in a form of a database, a file, and the like.

Thus, the information processing device according to the present embodiment determines the appropriate range of the coefficient and sets the range of the coefficient by referring to information about a past model (history of the model) and information representing the domain knowledge without requiring information input by the user.

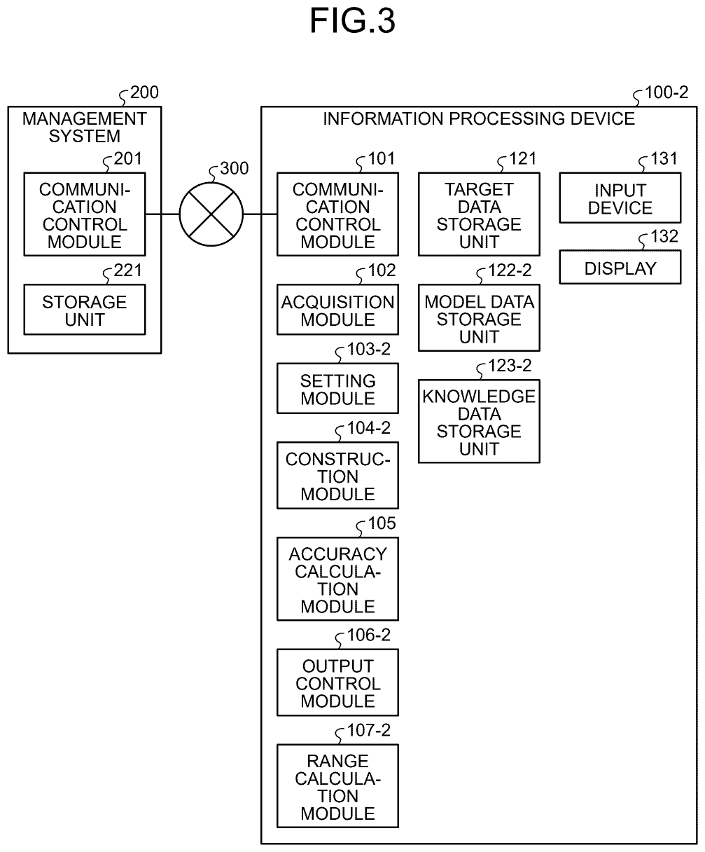

FIG. 3 is a block diagram illustrating an example of a configuration of the information processing system including an information processing device 100-2 according to the second embodiment. As illustrated in FIG. 3, the information processing system has a configuration in which the information processing device 100-2 and the management system 200 are connected via the network 300. The management system 200 and the network 300 are the same as those in the first embodiment, so that the same reference numerals are given thereto, and the description thereof will not be repeated.

The information processing device 100-2 includes the target data storage unit 121, a model data storage unit 122-2, a knowledge data storage unit 123-2, the input device 131, the display 132, the communication control module 101, the acquisition module 102, a setting module 103-2, a construction module 104-2, the accuracy calculation module 105, an output control module 106-2, and a range calculation module 107-2.

The second embodiment is different from the first embodiment in that the model data storage unit 122-2, the knowledge data storage unit 123-2, and the range calculation module 107-2 are added, and in functions of the setting module 103-2, the construction module 104-2, and the output control module 106-2. Other configurations and functions are the same as those in FIG. 1, which is the block diagram of the information processing device 100 according to the first embodiment, so that the same reference numerals are given thereto, and the description thereof will not be repeated.

The model data storage unit 122-2 stores model data about one or more models constructed in the past (past models). The past models are one or more constructed models (second models) to which a plurality of explanatory variables are input similarly to the model MA to be constructed. Hereinafter, the past model may be referred to as a model MB.

The model data includes, for example, a name of the explanatory variable (explanatory variable name), and the upper limit and the lower limit of the coefficient corresponding to the explanatory variable. The model data of the model MB may be acquired from the management system 200 and the like, and stored in the model data storage unit 122-2. The model MB may be a model constructed in the past by the information processing device 100, or a model constructed in the past by another device such as the management system 200, for example.

The knowledge data storage unit 123-2 stores knowledge data representing the domain knowledge previously obtained by the experts and the like, for example. The knowledge data is not necessarily set for all of the explanatory variables (coefficients), but is previously set for at least some of the explanatory variables (coefficients).

The knowledge data includes, for example, the name of the explanatory variable, presence/absence of a constraint, the upper limit, and the lower limit. The presence/absence of a constraint is information indicating whether to impose a constraint on the coefficient of the corresponding explanatory variable. For the presence/absence of a constraint, for example, “◯” is set if a constraint is present, and “x” is set if a constraint is absent. The knowledge data may be acquired from the management system 200 and the like, and stored in the knowledge data storage unit 123-2.

The range calculation module 107-2 calculates the upper limit and the lower limit of the coefficient corresponding to each explanatory variable using the model data of the model MB. For example, the range calculation module 107-2 calculates the upper limit and the lower limit using a range R2 (second range) of the value of the coefficient for the coefficients included in the model MB. The range R2 is, for example, a range from a minimum value to a maximum value of the values of the coefficients of each of the one or more models MB.

The range calculation module 107-2 calculates, as the upper limit, a value corresponding to a percentile (first percentile) determined by a designated value a among values in the range R2, for example. The range calculation module 107-2 also calculates, as the lower limit, a value corresponding to b percentile (second percentile) determined by a designated value b (b is a real number satisfying 0<b<a) among the values in the range R2. The value a and the value b are designated by the user, for example.

The setting module 103-2 sets the constraint condition used at the time of constructing the model MA using at least one of the knowledge data and the model data. In a case of using the knowledge data, the setting module 103-2 sets the constraint condition (range R1) using the knowledge data representing a lower limit L1 (first lower limit) and an upper limit U1 (first upper limit) of the value of the coefficient, for example.

In a case of using the model data, the setting module 103-2 sets the constraint condition (range R1) using the range R2. For example, the setting module 103-2 sets, as the range R1, a range from the lower limit to the upper limit calculated by the range calculation module 107-2 using the range R2. In the following description, the lower limit and the upper limit calculated by the range calculation module 107-2 using the range R2 are represented as a lower limit L2 and an upper limit U2, respectively.

In a case of using both of the knowledge data and the model data, the setting module 103-2 sets the constraint condition (range R1) using statistics (a maximum value, a minimum value, an average value, and the like) of the upper limit or the lower limit obtained from the knowledge data and the upper limit or the lower limit obtained from the model data. For example, the setting module 103-2 sets, as the range R1, a range including a statistic of the upper limit U1 obtained from the knowledge data and the upper limit U2 obtained from the model data, as the upper limit, and a statistic of the lower limit L1 obtained from the knowledge data and the lower limit L2 obtained from the model data, as the lower limit.

The construction module 104-2 is the same as the construction module 104 according to the first embodiment in that the model MA is constructed by obtaining the coefficients that satisfy the constraint condition set by the setting module 103-2. The construction module 104-2 may further have a function of constructing a model without a constraint condition. For example, the construction module 104-2 obtains a model without a constraint that is a model constructed by obtaining a plurality of coefficients without using the constraint condition. The model without a constraint can be used for comparison with the model MA that is constructed with the constraint condition, for example.

The output control module 106-2 is different from the output control module 106 according to the first embodiment in that the output control module 106-2 further outputs information about the model MB. For example, the output control module 106-2 outputs the coefficients included in the model MA together with the coefficients included in the model MB. In a case in which the model without a constraint is obtained, the output control module 106-2 may output the coefficients included in the model MA constructed with the constraint condition together with the coefficients included in the model without a constraint.

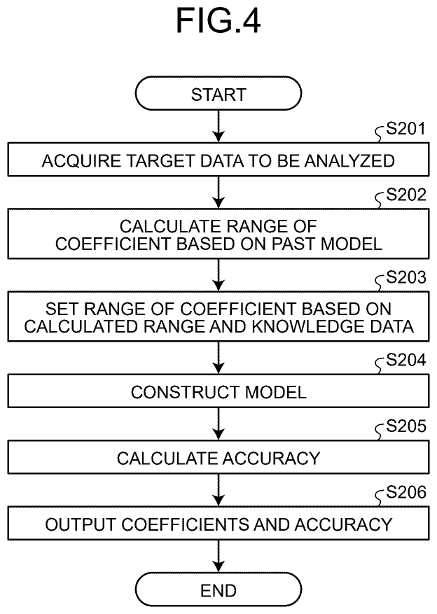

Next, the following describes information processing performed by the information processing device 100-2 according to the second embodiment with reference to FIG. 4. FIG. 4 is a flowchart illustrating an example of the information processing in the second embodiment.

The processing at Step S201 is the same as the processing at Step S101 performed by the information processing device 100 according to the first embodiment, so that the description thereof will not be repeated.

The range calculation module 107-2 reads out the model data of the model MB (past model) from the model data storage unit 122-2, for example, and calculates the range of the coefficient (the lower limit L2 and the upper limit U2) using the read-out model data (Step S202).

The setting module 103-2 sets the range R1 of the coefficient as the constraint condition used at the time of constructing the model MA based on the calculated range (range from the lower limit L2 to the upper limit U2) and the knowledge data read out from the knowledge data storage unit 123-2 (Step S203).

The processing at Step S204 to Step S206 is the same as the processing at Step S103 to Step S105 performed by the information processing device 100 according to the first embodiment, so that the description thereof will not be repeated.

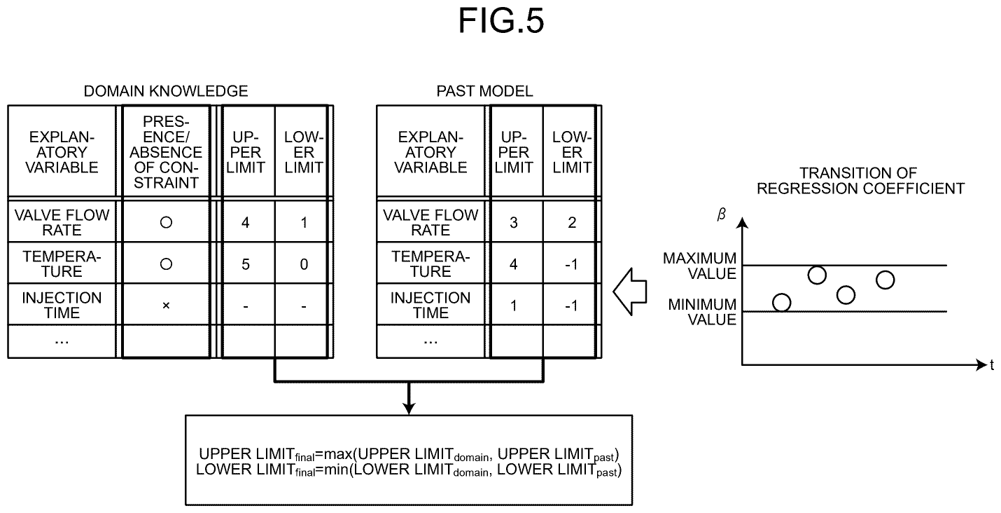

Next, the following further describes details about a setting method for the range of the coefficient according to the present embodiment. FIG. 5 is a diagram for explaining the setting method for the range of the coefficient.

The domain knowledge in FIG. 5 corresponds to the knowledge data stored in the knowledge data storage unit 123-2, for example. For example, as the domain knowledge about “valve flow rate”, the knowledge data is obtained such that presence/absence of a constraint is “◯” (a constraint is present), the upper limit of the corresponding coefficient is 4, and the lower limit of the coefficient is 1. In FIG. 5, the upper limit and the lower limit obtained as the domain knowledge are represented as an upper limit_{domain} and a lower limit_{domain}, respectively. The upper limit_{domain} and the lower limit_{domain} correspond to the upper limit U1 and the lower limit L1 described above, respectively.

A right graph in FIG. 5 is a graph representing changes of the coefficient corresponding to a certain explanatory variable (for example, “valve flow rate”). Such changes of the coefficient can be obtained from the model data of the models MB (past models). That is, changes of the value of the coefficient of the corresponding explanatory variable can be obtained from each of the models MB constructed at a plurality of times in the past.

A center table in FIG. 5 indicates an example of the range of the coefficient calculated from the past model. For example, the center table represents an example of the lower limit and the upper limit calculated by the range calculation module 107-2 using the range R2 determined with a minimum value and a maximum value of the coefficient indicated by the right graph. As described above, the upper limit and the lower limit are values within the range R2 corresponding to the a percentile and the b percentile, respectively. In FIG. 5, the upper limit and the lower limit obtained from the past model MB are represented as an upper limitₚₐₛₜ and a lower limitₚₐₛₜ, respectively. The upper limitₚₐₛₜ and the lower limitₚₐₛₜ correspond to the upper limit U2 and the lower limit L2 described above, respectively.

In the example of FIG. 5, for the explanatory variable with a constraint, the upper limit and the lower limit of the coefficient are obtained from both of the domain knowledge and the history of the model MB. By using them, for example, the setting module 103-2 sets an upper limit_{final} and a lower limit_{final} representing a final range of the coefficient as follows.
The upper limit_{final} is a maximum value of the upper limit_{domain} and the upper limitₚₐₛₜ.
The lower limit_{final} is a minimum value of the lower limit_{domain} and the lower limitₚₐₛₜ.

A setting method for the final range is not limited to the method described above. For example, the upper limit_{final} may be set by using another statistic (a minimum value, an average value, and the like) of the upper limit_{domain} and the upper limitₚₐₛₜ instead of the maximum value. The lower limit_{final} may be set by using another statistic (a maximum value, an average value, and the like) of the lower limit_{domain} and the lower limitₚₐₛₜ instead of the minimum value.

The setting module 103-2 may set, as the upper limit_{final}, any one of the upper limit_{domain} and the upper limitₚₐₛₜ. Similarly, the setting module 103-2 may set, as the lower limit_{final}, any one of the lower limit_{domain} and the lower limitₚₐₛₜ. Which of the domain knowledge and the history of the model MB is prioritized may be determined in accordance with information previously stored in a storage device and the like in the information processing device 100, for example.

The setting module 103-2 may set, as the final range (range from the lower limit_{final} to the upper limit_{final}), a range most similar to the range of the coefficient obtained from the domain knowledge (range from the lower limit_{domain} to the upper limit_{domain}) among ranges of the coefficient obtained from the history of the model MB.

If there is no overlap between the range of the coefficient obtained from the domain knowledge and the range of the coefficient obtained from the history of the model MB, a loss function obtained by giving a penalty (for example, an L1 penalty) to the corresponding coefficient may be used.

The construction module 104-2 constructs the model MA using the final range R1 of the coefficient set by the setting module 103-2. The construction module 104-2 may use any of the optimization methods described above. The construction module 104-2 may determine the optimization method to be applied in accordance with designation by the user and the like, for example.

There is a case in which the appropriate range of the coefficient cannot be set with only information about any one of the domain knowledge and the history of the model MA such as a case in which validity of values of the upper limit and the lower limit is difficult to be determined based on only the domain knowledge of the experts, and a case in which it is impossible to cope with a sudden change because a physical relation is unknown based on only the history of the past model MA. By referring to both of the domain knowledge and the history of the model MB and setting the range of the coefficient, such a problem can be avoided, and a more appropriate range R1 can be set. Additionally, for example, the experts may update the domain knowledge only when it is required, and a processing load for update can be reduced.

If information about only one of the domain knowledge and the history of the model MB is present for each of the explanatory variables, the range of the corresponding coefficient may be set using only the present information.

The setting module 103-2 may set the range of the coefficient in accordance with distribution of signs of the values of the coefficients included in the model MB. For example, for a certain explanatory variable, if a ratio of a corresponding coefficient having a certain sign (positive or negative) is equal to or larger than a designated threshold, the setting module 103-2 may set the range of the coefficient (the lower limitₚₐₛₜ and the upper limitₚₐₛₜ) to be a range corresponding to the sign. The range corresponding to the sign is, for example, a range satisfying the lower limitₚₐₛₜ=0 and the upper limitₚₐₛₜ=∞ in a case in which the sign is positive, and a range satisfying the lower limitₚₐₛₜ=−∞ and the upper limitₚₐₛₜ=0 in a case in which the sign is negative.

Next, the following describes an example of output by the output control module 106-2. As described above, the output control module 106-2 may output the coefficient of the model MB (past model) together with the estimated coefficient and the range of the coefficient determined by the system. The output control module 106-2 may output the value of the coefficient, or may output a graph and the like representing the coefficient instead of the value of the coefficient.

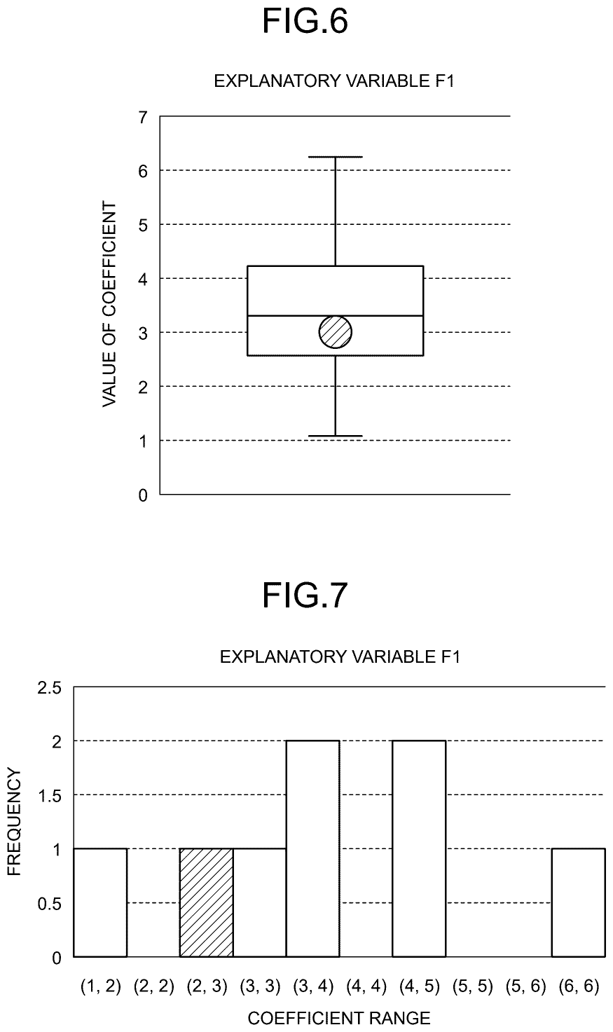

FIG. 6 to FIG. 10 are diagrams illustrating examples of a display screen output (displayed) by the output control module 106-2. Each of the diagrams corresponds to an example of the display screen output for a certain explanatory variable F1. A circle in FIG. 6 and FIG. 8 to FIG. 10 represents an estimated coefficient. In FIG. 7, a hatched part corresponds to the estimated coefficient.

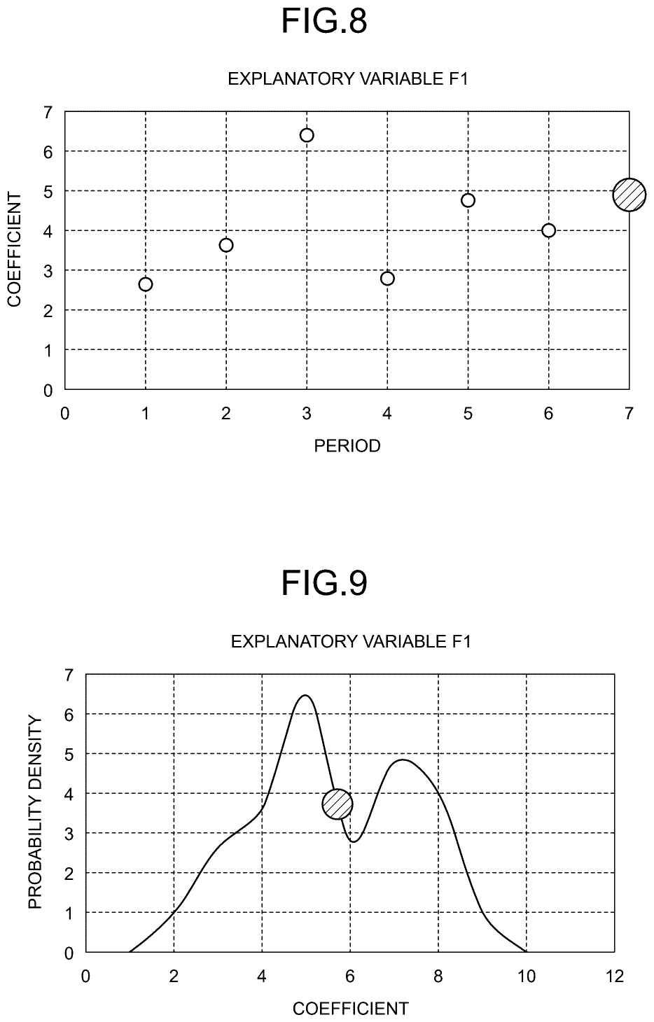

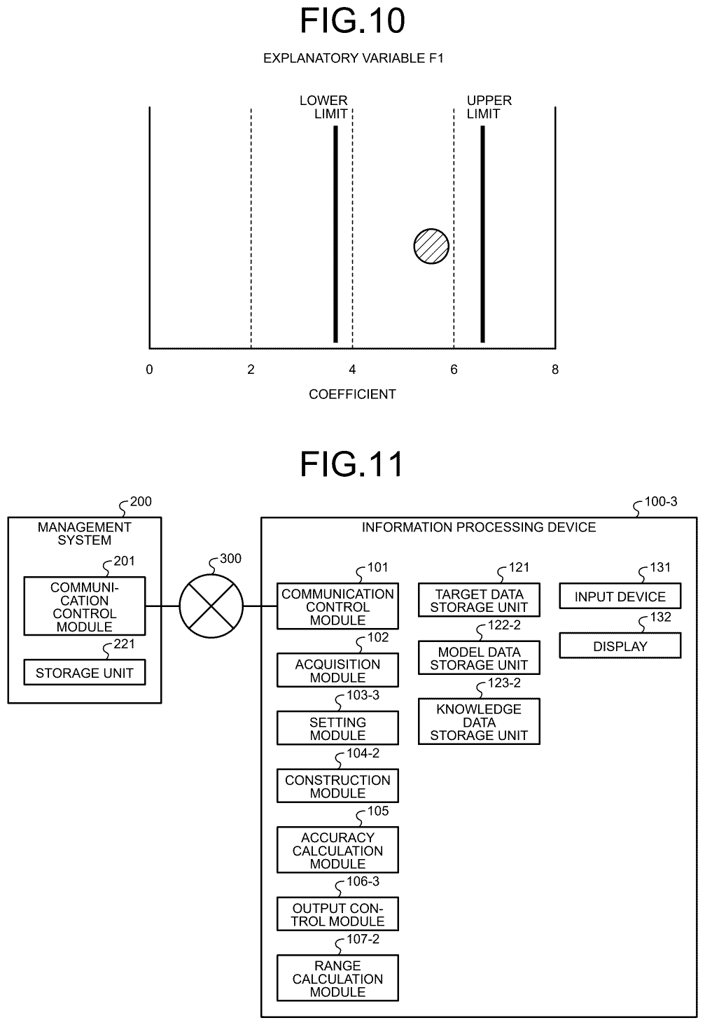

FIG. 6 is an example of the display screen represented by a box-and-whisker plot. FIG. 7 is an example of the display screen represented by a bar graph. FIG. 8 is an example of the display screen represented by a scatter diagram. FIG. 9 is an example of the display screen represented by distribution approximated by a nonparametric method. FIG. 10 is an example of the display screen including a lower limit and an upper limit of a coefficient represented by a line, and the estimated coefficient.

As described above, in the second embodiment, a more appropriate range of the coefficient can be set based on at least one of the domain knowledge and the coefficients of the model constructed in the past. Third embodiment

In a third embodiment, similarly to the second embodiment, the model MA is constructed by setting a more appropriate range R1 of the coefficient using the domain knowledge and the information about the model MB (past model). In the second embodiment, the range R1 of the coefficient that is obtained based on the domain knowledge and the information about the model MB is directly used for constructing the model MA. With such a method, a function of setting the range of the coefficient becomes a black box for the user, and the user cannot find how the range is set in detail.

Thus, the information processing device according to the third embodiment presents, to the user, an upper limit and a lower limit that are obtained based on the domain knowledge and the history of the model MB, and sets, as the final range R1, values of an upper limit and a lower limit designated (adjusted) by the user by referring to the presented information.

FIG. 11 is a block diagram illustrating an example of the configuration of the information processing system including an information processing device 100-3 according to the third embodiment. As illustrated in FIG. 11, the information processing system has a configuration in which the information processing device 100-3 and the management system 200 are connected via the network 300. The management system 200 and the network 300 are the same as those in the first embodiment, so that the same reference numerals are given thereto, and the description thereof will not be repeated.

The information processing device 100-3 includes the target data storage unit 121, the model data storage unit 122-2, the knowledge data storage unit 123-2, the input device 131, the display 132, the communication control module 101, the acquisition module 102, a setting module 103-3, the construction module 104-2, the accuracy calculation module 105, an output control module 106-3, and the range calculation module 107-2.

In the third embodiment, functions of the setting module 103-3 and the output control module 106-3 are different from those in the second embodiment. Other configurations and functions are the same as those in FIG. 3, which is the block diagram of the information processing device 100 according to the second embodiment, so that the same reference numerals are given thereto, and the description thereof will not be repeated.

The setting module 103-3 is the same as the setting module 103-2 according to the second embodiment in that the setting module 103-3 obtains the lower limit and the upper limit of the range of the coefficient using at least one of the knowledge data and the model data.

The output control module 106-3 is different from the output control module 106-2 according to the second embodiment in that the output control module 106-3 further has a function of outputting the lower limit and the upper limit of the range of the coefficient obtained by the setting module 103-3. For example, the output control module 106-3 outputs output information including at least one of the knowledge data representing the lower limit L1 and the upper limit U1, and the lower limit L2 and the upper limit U2 obtained from the range R2 of the coefficient included in the model MB.

The setting module 103-3 in the present embodiment is different from the setting module 103-2 in the second embodiment in that the setting module 103-3 sets the constraint condition (range R1) designated (adjusted) by the user, for example, based on the output information output by the output control module 106-3.

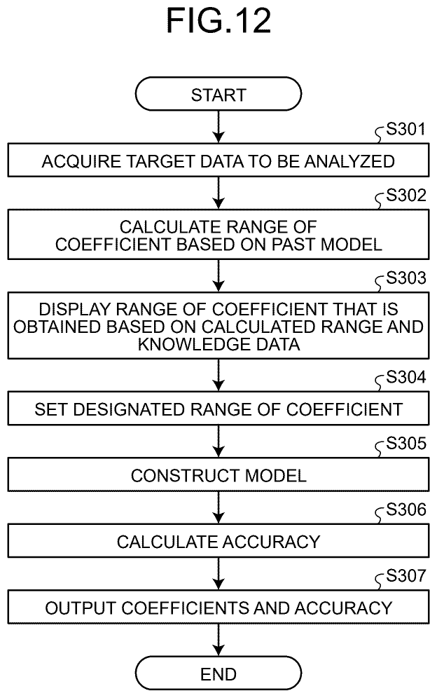

Next, the following describes information processing performed by the information processing device 100-3 according to the third embodiment with reference to FIG. 12. FIG. 12 is a flowchart illustrating an example of the information processing in the third embodiment.

The processing at Step S301 to Step S302 is the same as the processing at Step S201 to Step S202 performed by the information processing device 100-2 according to the second embodiment, so that the description thereof will not be repeated.

The output control module 106-3 causes, for example, the display 132 to display output information including the range of the coefficient set at Step S302 (the lower limit L2 and the upper limit U2) and the range of the coefficient obtained from the knowledge data (the lower limit L1 and the upper limit U1) (Step S303).

The setting module 103-3 refers to the displayed output information, and sets the range of the coefficient designated by the user, for example, as the range R1 of the coefficient as the constraint condition used at the time of constructing the model MA (Step S304).

The processing at Step S305 to Step S307 is the same as the processing at Step S204 to Step S206 performed by the information processing device 100-2 according to the second embodiment, so that the description thereof will not be repeated.

Next, the following describes an example of a display method for the output information. The output control module 106-3 displays the output information representing, as a graph or text, the upper limit U2 and the lower limit L2 obtained from the history of the model MB and the upper limit U1 and the lower limit L1 obtained from the domain knowledge for each explanatory variable, for example.

The output control module 106-3 may output the output information so that output modes of the lower limit and the upper limit are different from each other. The output modes are, for example, a color and a shape, but not limited thereto. The output control module 106-3 may output the output information represented by a scroll bar corresponding to the lower limit L1 to the upper limit U1, and a scroll bar corresponding to the lower limit L2 to the upper limit U2. The output control module 106-3 may obtain distribution of the values of the coefficients from the history of the model MB, and output the obtained distribution as the output information.

The information processing device 100-3 may further have a function of updating the domain knowledge using the range adjusted by the user.

As described above, in the third embodiment, the range of the coefficient (the upper limit and the lower limit) obtained by the information processing device is output, and the user is enabled to adjust he range of the coefficient. That is, final determination of the range R1 can be performed by the user.

### Fourth Embodiment

The second embodiment describes a form of setting a more appropriate range of the coefficient by using the coefficients of the model MB (past model). In a fourth embodiment, information about a model in a similar environment is used instead of the model MB.

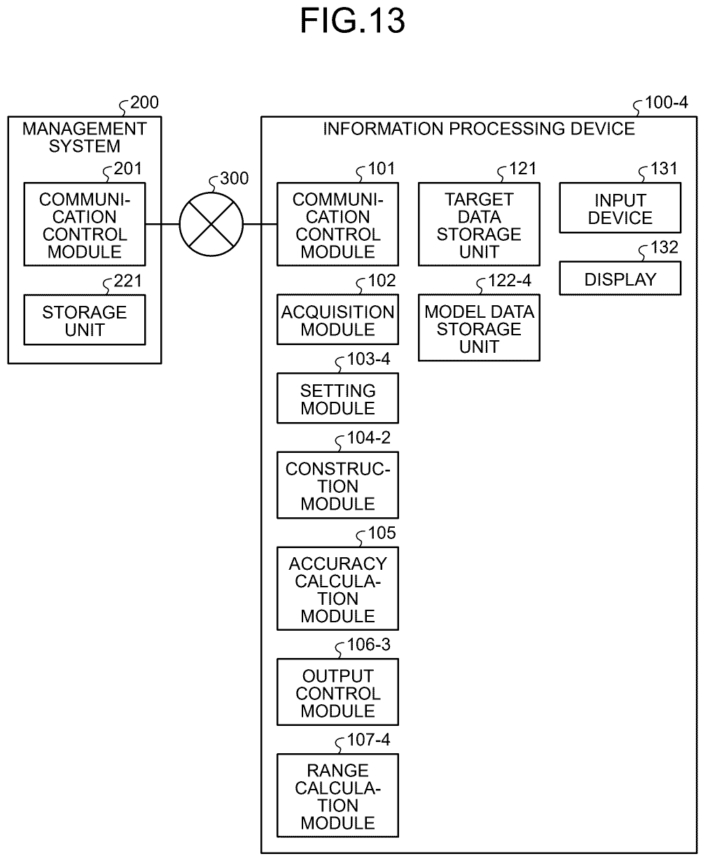

FIG. 13 is a block diagram illustrating an example of the configuration of the information processing system including an information processing device 100-4 according to the fourth embodiment. As illustrated in FIG. 13, the information processing system has a configuration in which the information processing device 100-4 and the management system 200 are connected via the network 300. The management system 200 and the network 300 are the same as those in the first embodiment, so that the same reference numerals are given thereto, and the description thereof will not be repeated.

The information processing device 100-4 includes the target data storage unit 121, a model data storage unit 122-4, the input device 131, the display 132, the communication control module 101, the acquisition module 102, a setting module 103-4, the construction module 104-2, the accuracy calculation module 105, the output control module 106-3, and a range calculation module 107-4.

The third embodiment is different from the second embodiment in that the knowledge data storage unit 123-2 is deleted, and in functions of the model data storage unit 122-4, the setting module 103-4, and the range calculation module 107-4. Other configurations and functions are the same as those in FIG. 3, which is the block diagram of the information processing device 100 according to the second embodiment, so that the same reference numerals are given thereto, and the description thereof will not be repeated.

The model data storage unit 122-4 stores model data about one or more models (similar models) similar to the model MA to be constructed. The similar model is a model (third model) that inputs at least some of the explanatory variables of the model MA to be constructed and performs estimation. Hereinafter, the similar model may be referred to as a model MC. The model data of the model MC may be acquired from the management system 200 and the like, and stored in the model data storage unit 122-4.

The similar model (model MC) corresponds to a model used in an environment similar to an environment in which the model MA is used, for example. The similar environment is, for example, a plurality of environments as follows.
A plurality of environments corresponding to a plurality of machines produced by the same manufacturer
A plurality of environments corresponding to a plurality of kinds of products produced in the same factory
A plurality of environments in which the same types of sensors disposed at different places are used
A plurality of environments in which inspection is performed on each of the same products

The range calculation module 107-4 calculates the upper limit and the lower limit of the coefficient corresponding to each explanatory variable using the model data of the model MC. The function of the range calculation module 107-4 is the same as that of the range calculation module 107-2 according to the second embodiment except that the model MC is used instead of the model MB.

For example, the range calculation module 107-4 calculates the upper limit and the lower limit using a range R3 of a value of a coefficient for each of a plurality of coefficients having a name or meaning that is the same as or similar to that of the model MA, among the coefficients included in the model MC. The range R3 is, for example, a range from a minimum value to a maximum value among values of the coefficients of each of the one or more models MC. For example, the range calculation module 107-4 can specify a coefficient having the same or similar name or meaning using correspondence information indicating a correspondence between the coefficients of the model MA and the coefficients of the model MC determined in advance.

The range calculation module 107-4 calculates, as the upper limit, a value corresponding to the a percentile determined by the designated value a among values in the range R3, for example. The range calculation module 107-4 also calculates, as the lower limit, a value corresponding to the b percentile determined by the designated value b among the values in the range R3.

The setting module 103-4 sets the constraint condition (range R1) used at the time of constructing the model MA using the range R3. For example, the setting module 103-4 sets, as the range R1, a range from the lower limit to the upper limit calculated by a range calculation module 107-3 using the range R3. In the following description, the lower limit and the upper limit calculated by the range calculation module 107-4 using the range R3 are represented as a lower limit L3 and an upper limit U3, respectively.

There may be a plurality of similar environments similar to the environment in which the model MA is used. In each of the similar environments, a plurality of the models MC that are constructed at a plurality of times in the past may be used. That is, for each explanatory variable, the upper limit U3 and the lower limit L3 may be obtained by using l×m coefficients at maximum obtained from m (m is an integer number equal to or larger than 1) models MC in l (l is an integer number equal to or larger than 1) similar environments.

By combining the second embodiment with the fourth embodiment, the final upper limit and lower limit (range R1) may be obtained by using one or more of the upper limit and the lower limit obtained from the history of the model MC, the upper limit and the lower limit obtained from the domain knowledge, and the upper limit and the lower limit obtained from the model MB.

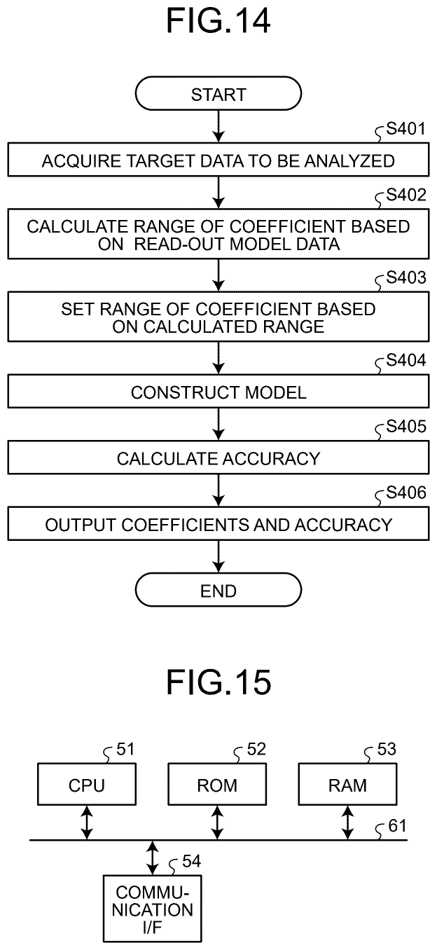

Next, the following describes information processing performed by the information processing device 100-4 according to the fourth embodiment with reference to FIG. 14. FIG. 14 is a flowchart illustrating an example of the information processing in the fourth embodiment.

The processing at Step S401 is the same as the processing at Step S201 performed by the information processing device 100-2 according to the second embodiment, so that the description thereof will not be repeated.

The range calculation module 107-4 reads out the model data of the model MC from the model data storage unit 122-4, for example, and calculates the range of the coefficient (the lower limit L3 and the upper limit U3) using the read-out model data (Step S402).

The setting module 103-4 sets the range R1 of the coefficient as the constraint condition used at the time of constructing the model MA based on the calculated range (range from the lower limit L3 to the upper limit U3) (Step S403).

The processing at Step S404 to Step S406 is the same as the processing at Step S204 to Step S206 performed by the information processing device 100-2 according to the second embodiment, so that the description thereof will not be repeated.

As described above, in the fourth embodiment, even in a case in which the domain knowledge and the history of the model MB (past model) cannot be obtained, or a case in which an amount of the domain knowledge and the history of the model MB is small, an appropriate range of the coefficient can be obtained to be used as a constraint at the time of constructing the model by referring to the information about the model in the similar environment.

As described above, according to the first to the fourth embodiments, a more appropriate model can be constructed as a model for performing analysis about the production system and the like.

Next, the following describes a hardware configuration of the information processing device according to the first to the fourth embodiment with reference to FIG. 15. FIG. 15 is an explanatory diagram illustrating a hardware configuration example of the information processing device according to the first to the fourth embodiments.

The information processing device according to the first to the fourth embodiments includes a control device such as a central processing unit (CPU) 51, a storage device such as a read only memory (ROM) 52 and a random access memory (RAM) 53, a communication I/F 54 that is connected to a network to perform communication, and a bus 61 that connects the respective components.

A computer program executed by the information processing device according to the first to the fourth embodiments is embedded and provided in the ROM 52 and the like.

The computer program executed by the information processing device according to the first to the fourth embodiments may be recorded in a computer-readable recording medium such as a compact disc read only memory (CD-ROM), a flexible disk (FD), a compact disc recordable (CD-R), and a digital versatile disc (DVD), as an installable or executable file to be provided as a computer program product.

Furthermore, the computer program executed by the information processing device according to the first to the fourth embodiments may be stored in a computer connected to a network such as the Internet and provided by being downloaded via the network. The computer program executed by the information processing device according to the first to the fourth embodiments may be provided or distributed via a network such as the Internet.

The computer program executed by the information processing device according to the first to the fourth embodiments may cause a computer to function as each of the components of the information processing device described above. With this computer, the CPU 51 can read out, from a computer-readable storage medium, a computer program to a main storage device to be executed.

The following describes configuration examples of the embodiments.

### Configuration Example 1

An information processing device includes:
one or more processors configured to:
   set, for each of a plurality of parameters corresponding to a plurality of explanatory variables included in a first model that inputs the plurality of explanatory variables and performs estimation, a constraint condition including a first range of a value of the corresponding parameter; and
   construct the first model by obtaining the plurality of parameters that satisfy the constraint condition.

### Configuration Example 2

In the device according to Configuration example 1, the one or more processors are configured to set the constraint condition by using knowledge data that is previously obtained for at least some of the plurality of parameters and represents a lower limit and an upper limit of the values of the parameters.

### Configuration Example 3

In the device according to Configuration example 1 or 2, the one or more processors are configured to set the constraint condition by using a second range of values of the plurality of parameters included in one or more constructed second models that input the plurality of explanatory variables.

### Configuration Example 4

In the device according to Configuration example 3, the one or more processors are configured to set, as the first range, a range including, among the values in the second range, a value corresponding to a first percentile as an upper limit, and a value corresponding to a second percentile smaller than the first percentile as a lower limit.

### Configuration Example 5

In the device according to Configuration example 4,
the one or more processors are configured to, by using knowledge data that is previously obtained for at least some of the plurality of parameters and represents a first lower limit and a first upper limit of the values of the plurality of parameter, set, as the first range, a range including
   a statistic of the first upper limit and the value corresponding to the first percentile among the values in the second range, as an upper limit, and
   a statistic of the first lower limit and the value corresponding to the second percentile among the values in the second range, as a lower limit.

### Configuration Example 6

In the device according to Configuration example 3, the one or more processors are configured to set a range of the values of the parameters included in the constraint condition in accordance with distribution of signs of the values of the plurality of parameters included in the second model.

### Configuration Example 7

In the device according to Configuration example 1, the one or more processors are configured to set the constraint condition by using a range of the values of the plurality of parameters included in one or more third models that input at least some of the plurality of explanatory variables and perform estimation.

### Configuration Example 8

In the device according to Configuration example 1,
the one or more processors are configured to:
   output information including at least one of knowledge data that is previously obtained for at least some of the plurality of parameters and represents a lower limit and an upper limit of the values of the parameters, and a lower limit and an upper limit that are obtained from a second range of the values of the parameters included in one or more constructed second models that input the plurality of explanatory variables; and
   further set the constraint condition that is designated based on the output information.

### Configuration Example 9

In the device according to Configuration example 1, the one or more processors are configured to construct the first model by obtaining the plurality of parameters by using a loss function with which a loss becomes smaller as a degree of satisfaction of the constraint condition is higher.

### Configuration Example 10

In the device according to any one of Configuration examples 1 to 9,
the one or more processors are configured to:
   obtain a model without a constraint as the first model that is constructed by obtaining the plurality of parameters without using the constraint condition; and
   together output the plurality of parameters included in the first model and the plurality of parameters included in the model without a constraint.

### Configuration Example 11

In the device according to any one of Configuration examples 1 to 10, the one or more processors are configured to together output the plurality of parameters included in the first model and the plurality of parameters included in one or more constructed second models that input the plurality of explanatory variables.

### Configuration Example 12

An information processing method, performed by an information processing device, includes:
setting, for each of a plurality of parameters corresponding to a plurality of explanatory variables included in a first model that inputs the plurality of explanatory variables and performs estimation, a constraint condition including a first range of a value of the corresponding parameter; and
constructing the first model by obtaining the plurality of parameters that satisfy the constraint condition.

### Configuration Example 13

A computer program product includes a computer-readable medium including programmed instructions, the instructions causing a computer to execute:
setting, for each of a plurality of parameters corresponding to a plurality of explanatory variables included in a first model that inputs the plurality of explanatory variables and performs estimation, a constraint condition including a first range of a value of the corresponding parameter; and
constructing the first model by obtaining the plurality of parameters that satisfy the constraint condition.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more processors configured to:
set, for each of a plurality of parameters corresponding to a plurality of explanatory variables included in a first model that inputs the plurality of explanatory variables and performs estimation, a constraint condition including a first range of a value of the corresponding parameter; and
construct the first model by obtaining the plurality of parameters that satisfy the constraint condition.

2. The device according to claim 1, wherein the one or more processors are configured to set the constraint condition by using knowledge data that is previously obtained for at least some of the plurality of parameters and represents a lower limit and an upper limit of the values of the parameters.

3. The device according to claim 1, wherein the one or more processors are configured to set the constraint condition by using a second range of values of the plurality of parameters included in one or more constructed second models that input the plurality of explanatory variables.

4. The device according to claim 3, wherein the one or more processors are configured to set, as the first range, a range including, among the values in the second range, a value corresponding to a first percentile as an upper limit, and a value corresponding to a second percentile smaller than the first percentile as a lower limit.

5. The device according to claim 4, wherein
the one or more processors are configured to, by using knowledge data that is previously obtained for at least some of the plurality of parameters and represents a first lower limit and a first upper limit of the values of the plurality of parameter, set, as the first range, a range including
a statistic of the first upper limit and the value corresponding to the first percentile among the values in the second range, as an upper limit, and
a statistic of the first lower limit and the value corresponding to the second percentile among the values in the second range, as a lower limit.

6. The device according to claim 3, wherein the one or more processors are configured to set a range of the values of the parameters included in the constraint condition in accordance with distribution of signs of the values of the plurality of parameters included in the second model.

7. The device according to claim 1, wherein the one or more processors are configured to set the constraint condition by using a range of the values of the plurality of parameters included in one or more third models that input at least some of the plurality of explanatory variables and perform estimation.

8. The device according to claim 1, wherein
the one or more processors are configured to:
output information including at least one of knowledge data that is previously obtained for at least some of the plurality of parameters and represents a lower limit and an upper limit of the values of the parameters, and a lower limit and an upper limit that are obtained from a second range of the values of the parameters included in one or more constructed second models that input the plurality of explanatory variables; and
further set the constraint condition that is designated based on the output information.

9. The device according to claim 1, wherein the one or more processors are configured to construct the first model by obtaining the plurality of parameters by using a loss function with which a loss becomes smaller as a degree of satisfaction of the constraint condition is higher.

10. The device according to claim 1, wherein
the one or more processors are configured to:
obtain a model without a constraint as the first model that is constructed by obtaining the plurality of parameters without using the constraint condition; and
together output the plurality of parameters included in the first model and the plurality of parameters included in the model without a constraint.

11. The device according to claim 1, wherein the one or more processors are configured to together output the plurality of parameters included in the first model and the plurality of parameters included in one or more constructed second models that input the plurality of explanatory variables.

12. An information processing method performed by an information processing device, the method comprising:
setting, for each of a plurality of parameters corresponding to a plurality of explanatory variables included in a first model that inputs the plurality of explanatory variables and performs estimation, a constraint condition including a first range of a value of the corresponding parameter; and
constructing the first model by obtaining the plurality of parameters that satisfy the constraint condition.

13. A computer program product comprising a non-transitory computer-readable medium including programmed instructions, the instructions causing a computer to execute:
setting, for each of a plurality of parameters corresponding to a plurality of explanatory variables included in a first model that inputs the plurality of explanatory variables and performs estimation, a constraint condition including a first range of a value of the corresponding parameter; and
constructing the first model by obtaining the plurality of parameters that satisfy the constraint condition.
